(19) United States
(12) Patent Application Publication
(10) Pub. No.: US 2010/0023795 A1
(43) Pub. Date: Jan. 28, 2010

(54) METHOD FOR HANDLING DATA

(76) Inventors: Andreas Rupp, Oehringen (DE); Rainer Baumgaertner, Pfaffenhofen (DE)

Correspondence Address: KENYON & KENYON LLP, ONE BROADWAY, NEW YORK, NY, 10004, US

(21) Appl. No.: 12/304,658

(22) PCT Filed: Nov. 21, 2007
(86) PCT No.: PCT/EP2007/062655

§ 371 Date: Oct. 9, 2009

(30) Foreign Application Priority Data
Nov. 21, 2006 (DE) 10 2006 054 704.7

(51) Int. Cl. G06F 1/04

(52) U.S. Cl. 713/503

(57) ABSTRACT

A method for handling data in which a serial data flow, with which a plurality of data is transmitted simultaneously per line, is transmitted using a serial protocol, which is formed from data blocks and synchronization blocks.

### FIELD OF THE INVENTION

The present invention relates to a method for handling data, a device for handling data, a computer program, and a computer program product.

### BACKGROUND INFORMATION

Normally pulse-width modulation signals (PWM signals) or serial interfaces having so-called handshake lines, timing circuits, and sync lines are used to control valve output stages. Serial protocols, which require additional handshake lines, timing circuits, and sync lines, are designed for longer transmission paths. However, such protocols use only one part of the possibilities that exist for short-distance transmissions, such as between a computer and a valve output stage, for example. They use a possibly existing synchrony of transmitter and receiver just as little. Apart from this, to synchronize, these protocols need a resting phase on the line, which is why they are not presently used in control units.

A method for controlling a control element is described in DE 199 50 027. In this context, the control element is able to be controlled by a pulse-shaped control signal, a first period duration specifying a first pulse sequence and a second period duration determining a variable that establishes the pulse duration of the control signal. After each determination of the variable that specifies the pulse duration of the control signal, a pulse of the control signal is triggered and the first pulse sequence is restarted.

DE 100 05 154 relates to a method for establishing a communication between two participants of a bus system and for loading data via the bus system. In this instance the data are loaded into a memory of a first participant and the data are sent by a second participant. The bus system has a predefinable transmission rate that is valid for all participants and at which all participants communicate during operation. The transmission of the data is carried out in the form of frames that contain an identifier. In this context, each bus participant is equally able to send frames and each participant may detect and receive frames specified for it by the identifier. It is provided that the first participant receives frames from the second participant if the second participant sends at least one frame that differs from the predefined transmission rate.

A system for superimposing information is described in DE 196 21 902. In this context, information is represented by an analog signal that periodically has two predefinable levels, by the period duration of the analog signal. This ensues with a generated digital signal that represents information in the form of a digital data word. To form a superimposed signal, the digital signal is superimposed on the analog signal.

### SUMMARY

Example embodiments of the present invention relate to a method for handling data. In this context, a serial data flow, with which a plurality of data is transmitted simultaneously per line, is transmitted using a serial protocol that is formed from data blocks and synchronization blocks.

In example embodiments, the synchronization blocks carry out a synchronization of the data blocks. In an example embodiment of the method, the protocol may be generated by a timer unit, for example, a high-end timer.

In the method, it may additionally be possible to transmit the data time-synchronously or simultaneously, and/or continuously. Of course, the data may also be transmitted in a time-delayed manner as well as discontinuously.

Normally, the data are transmitted from a transmitter, for example, a central processor, to a receiver, for example, an output stage or valve output stage. In this context, it is normally provided that the transmitter uses the serial protocol to control the receiver.

Furthermore, the data may be transmitted in particular while taking into account a synchrony or simultaneity between the transmitter and the receiver. In one design, the receiver is resynchronized after one cycle.

In example embodiments, one data block respectively is shorter than a low phase of a synchronization block designed as a master-sync block. Furthermore, it is possible for the receiver to utilize at least one synchronization block to check consistency.

Furthermore, example embodiments of the present invention relate to a system for handling data, which is designed to transmit a serial data flow, with which a plurality of data is to be transmitted simultaneously per line, using a serial protocol that is formed from data blocks and synchronization blocks.

Individual or all steps of the method according to example embodiments of the present invention are able to be performed using this system or individual components of this system. The system may include a transmitter, for example, a control unit, in particular having a central processor, as well as a receiver, for example, an external module such as an output stage, in particular a valve output stage, or a sensor and/or actuator.

The computer program having a program code arrangement according to example embodiments of the present invention is designed to implement all steps of a method according to example embodiments of the present invention, when the computer program is executed on a computer or a corresponding central processor, especially in a system according to example embodiments of the present invention.

Example embodiments of the present invention also relate to a computer program product having a program code arrangement, which is stored on a computer-readable storage medium, in order to execute all steps of a method according to example embodiments of the present invention if the computer program is executed on a computer or a corresponding central processor, in particular in a system according to example embodiments of the present invention.

Example embodiments of the present invention provide in particular a serial control protocol for transmitting different signals or data. The serial protocol to be provided via the method is suitable for controlling so-called Gen9 valve output stages in combustion engines of motor vehicles and/or brake control units for motor vehicles.

Example embodiments of the present invention may satisfy requirements relating to a noise optimization and of various control profiles, since now a transmission of large data quantities is also possible. It is possible to dispense with the cost-intensive and inflexible implementation of the required functionalities in the hardware. Using example embodiments of the present invention, it possible to transmit more than two different pieces of information via one line, for example, in a transmission by PWM signals. The reading of the PWM signals on one side of the receiver is normally insensitive to basic frequency fluctuations between transmitter and receiver. Additionally, in the serial transmission, as a rule, no additional handshake lines, timing circuits, and/or sync lines are required.

By introducing the new protocol for controlling, which typically gets along without additional handshake, clock, and sync signals, it is possible to transmit a data flow within the system, for example, from the central processor to the output stage or valve output stage, a minimal number of lines, in particular only one line, being required.

Components of the protocol, which are designed as synchronization blocks, such as re-sync blocks and master-sync blocks, allow for the quick new synchronization and the resynchronization between data blocks. Furthermore, the synchrony of transmitter and receiver may be used via a basic clock pulse for the cost-effective implementation of the receiver.

By standardizing the protocol used, it is typically possible to use the same protocol to interconnect a plurality of devices that function identically, in particular output stages and the like, without having to adapt a separate protocol for each combination of devices. In this context, it is possible to achieve a scalability like in PWM output stages, which means that additionally different data content may be transported on one line, as is common in a serial interface, for example.

In example embodiments, a timer unit designed as a high-end timer (HET) is used to generate the protocol. In this way, it is possible to efficiently use resources of the central processor or of a computer, only a minimal computing time being required for the control of the output stage, for example. Additionally, the timer unit or possibly a coprocessor may take over specific subtasks. The quick cyclical transmission by a coprocessor reduces the workload of the computer as long as subfunctions are required. To this end, example embodiments provide that the low-end range and the high-end range use the same driver output stage, so that in this context only a part of the functionalities must be provided or represented.

The protocol for control is not restricted to valve output stages; it may be used for any type of functional modules, for example, of actuators and also sensors, which as a rule interact with a control unit. In this manner, it is also possible to use the protocol for a valve control in which a plurality of information is transmitted via one serial data flow per line.

Among other things, example embodiments of the present invention result in a reduction in the transmission lines required in comparison with the PWM control. Apart from this, it is possible to distribute the information to be transmitted or payload data to a plurality of relatively low-frequency and anti-interference lines. Thus, in comparison to the PWM transmission, a plurality of payload data and thus pieces of information is able to be transmitted on one data line.

In comparison to serial interfaces, in example embodiments of the present invention, a time-synchronous continuous transmission of the signals, payload information or payload data is able to be performed, which as a rule takes place without additional sync, handshake, and clock signals. Furthermore, an improved safety concept results, in case a response takes place via another serial interface protocol. This is possible because the number of necessary lines may be kept low in an implementation of the method.

Example embodiments of the system typically result in a simple structure of the receiver or the receiver part, as well as in particular a simple synchronization. Synchronies between transmitters and receivers may now be used at will.

It should be pointed out that in the following description of an additional exemplary embodiment of the present invention the terms “low” and “high” may be exchanged. A protocol resulting from an exchange is merely inverted, but is functionally equivalent.

The data provided for valve control in the exemplary embodiment are output by the transmitter, here the computer, in the serial data flow. The data flow is structured such that no explicit sync lines, timing circuits, or handshake lines are necessary between the sender and the receiver, which is designed here as a valve output stage.

The protocol for controlling is normally made up of data and synchronization blocks. A data block is made up of a number of bits having the same length. Synchronization blocks are also made up of a number of bits having the same length. In order to satisfy specific timing requirements, re-sync blocks and master-sync blocks that are likewise to be provided may have lengths that are not integrally divisible by a respective bit length. Re-sync blocks are at least larger than one bit and contain a low-to-high or a high-to-low transition. In this context, as a rule, a low phase of master-sync blocks is larger than the largest data block in the protocol.

The transmission may take place cyclically, for example, every 250 μs; however, it may also take place acyclically; in this context, a high-level lies on one line, for example, a signal line, during a time between the transmission phases, so that the master-sync block is able to be uniquely detected by the receiver. If receiver and transmitter use the same basic pulse, it suffices for the receiver to wait only for the arrival of a master-sync block, which is recognizable by the so-called low time. A bit midpoint of the protocol bit may be synchronized using a low-to-high edge in the master-sync block. If no shared basic pulse exists between transmitter and receiver, the receiver may determine the size of the protocol bit by measuring the master-sync block. The size of the master-sync block is defined by a maximum low time in the design. Using the low-to-high edge in the master-sync block, the receiver may synchronize itself with the bit midpoint of the protocol bit just like in the synchronous case. The edges of the re-sync blocks may be used by the receiver for resynchronization between the master-sync blocks. The sync bits are used to restrict the number of low phases occurring in the protocol. In one possible embodiment, the edges described may be designed as start or stop bits, and as synchronization bits.

Further advantages and aspects of example embodiments of the present invention are described in more detail below with reference to the appended Figures.

It is understood that the aforementioned features and the features yet to be explained below may be used not only in the combination indicated in each instance, but also in other combinations or by themselves, without departing from the scope of the present invention.

### BRIEF DESCRIPTION OF THE DRAWINGS

FIG. 1 illustrates schematically an example embodiment of a serial protocol.

FIG. 2 shows in a schematic representation an example of a conventional valve driver.

FIG. 3 shows in a schematic representation an example embodiment of a valve output stage in an example embodiment of the system according to the present invention.

FIG. 4 shows in a schematic representation an example embodiment of a valve output stage in an example embodiment of the system according to the present invention.

FIG. 5 shows in a schematic representation an example embodiment of the system according to the present invention having a plurality of valve output stages.

FIG. 6 shows in a schematic representation an example embodiment of the serial protocol.

### DETAILED DESCRIPTION

Example embodiments of the present invention are represented schematically in the drawing, and are described in detail below with reference to the drawing.

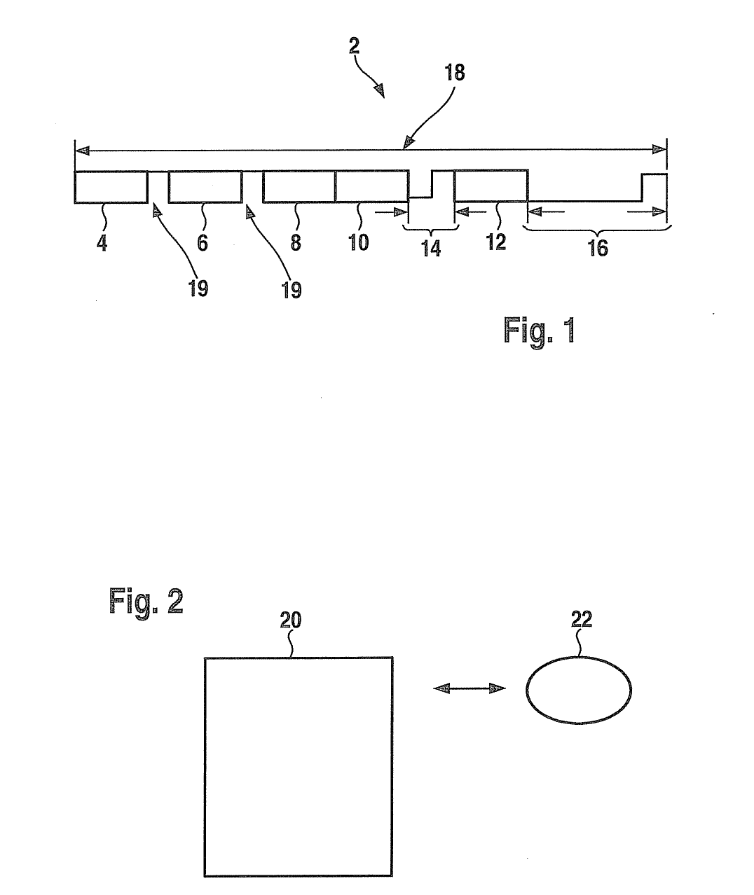

FIG. 1 shows an example embodiment of a serial protocol 2 for valve control of two valves, the protocol having one data block 4, 6, 8, 10, 12 respectively for one task respectively, and one frequency or period duration per valve. In this context, the following is provided: a first data block 4 for a “valve control parameter value 1,” a second data block 6 for a “valve control parameter value 2,” a third data block 8 for a “valve control parameter value 3,” a fourth data block 10 for a “valve control parameter value 4,” and a fifth data block 12 for “aux,” in which auxiliary information for different functions is stored. This auxiliary information is provided for data synchronization, for controlling monitoring and test procedures, or for turning on and off valves and other functions, for example. Existing protocol 2 furthermore includes a re-sync block 14 and a master-sync block 16 and thus two synchronization blocks. Individual data blocks 4, 6, 8, 10, 12 for the four valve control parameter values and for “aux” are all shorter than a low phase of master-sync block 16. In this manner, a situation is achieved in which the valve output stage newly synchronizes at the latest after one cycle 18 of protocol 2, which lasts 250 μS here.

In the existing embodiment, serial protocol 2 is suitable for handling data that are transmitted from a transmitter to a receiver. In this context, protocol 2 made up of data blocks 4, 6, 8, 10, 12 and the synchronization blocks transmits a serial data flow, with which a plurality of data are transmitted simultaneously per line.

Both synchronization blocks, that is, re-sync block 14 and master-sync block 16, perform one synchronization 19 of these data blocks 4, 6, 8 respectively, between first data block 4 and second data block 6, and between second data block 4 and third data block 8.

At one edge of re-sync block 14, prior to the occurrence of the next master-sync block 18, the valve output stage, as a receiver, may newly synchronize itself to the bit positions in serial protocol 2 for transmitting the data flow. Sync bits (synchronization bits) of re-sync block 14 and of master-sync block 16 may be utilized by the receiver to check the consistency of protocol 2.

FIG. 2 shows in a schematic representation an example of a conventional valve driver 20, which is connected to a serial peripheral interface 22 that is buffered multiple times (MIBSPI or multi-buffered-serial peripheral interface). This valve driver 20 has a minimal number of connections, in the existing case only one connection. However, functioning of this valve driver is heavily dependent on fluctuations of the tasks to be managed. Furthermore, a functionality for supporting a valve must be implemented in hardware. This in turn means that high hardware costs accrue if many applications are to be provided. In this instance as well, two concepts are required for valve driver 20, to with one concept for the so-called low-end range and one for the so-called high-end range, which results in a low flexibility of valve driver 20.

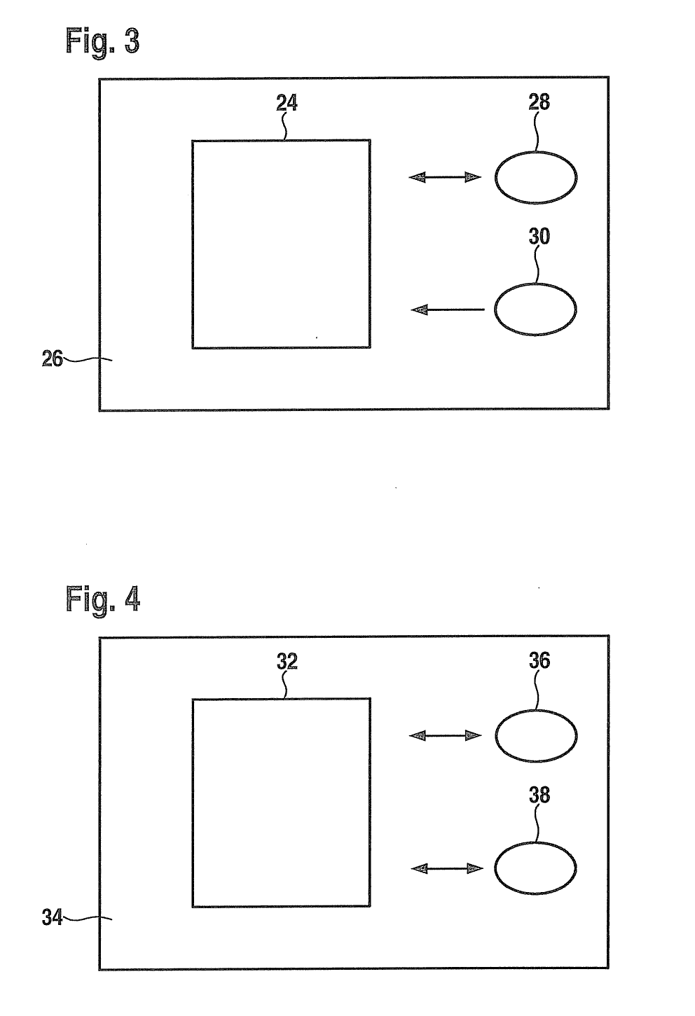

FIG. 3 shows in a schematic representation an example embodiment of a valve output stage 24 in an example embodiment of system 26 according to the present invention. System 26 additionally has a central processor of a control unit, which is not shown. In this context, the central processor is provided as a transmitter and valve output stage 24 as a receiver. System 26 is designed to transmit a serial data flow, with which a plurality of data are transmitted simultaneously per line, using a serial protocol, which is formed from data blocks and synchronization blocks, from the central processor to valve output stage 24.

This valve output stage 24 and thus a corresponding valve driver is connected via a first connection to a serial peripheral interface 28 that is buffered multiple times. Data and thus also signals are exchanged between valve output stage 24 and interface 28. In the existing specific embodiment, interface 28 is provided primarily for monitoring. Valve output stage 24 is connected, in this example embodiment using twelve second connections, via a pulse-width modulation to a timer unit 30 designed as a high-end timer.

In this example embodiment, a runtime is a function of a complexity of the valve to be acted upon and is scalable in a suitable way. Apart from this, when the valve is acted upon, a high performance and thus capacity is provided. A functionality for synchronizing the valve is also implementable by software. In particular, a high flexibility is available in the high-end range in existing valve output stage 24.

An example embodiment of a valve output stage 32 in an example embodiment of a system 34 according to the present invention is illustrated schematically in FIG. 4. A central processor, which is not shown, of a control unit is provided as an additional module of system 34. In this context, the central processor is defined as a transmitter and valve output stage 32 as a receiver. In an example embodiment of the method according to the present invention, it is provided that a serial data flow, with which a plurality of a data is transmitted simultaneously per line, is transmitted from the central processor to valve output stage 32 using a serial protocol that is formed from data blocks and synchronization blocks.

This valve output stage 32, and thus a corresponding valve driver, is also connected via a first connection to a serial peripheral interface 36 that is buffered multiple times and that is designed for monitoring. Data and thus also signals are exchanged between valve output stage 32 and interface 36. Additionally, in this instance, depending on requirements, four to six second connections are provided, via which valve output stage 32 is connected via pulse-width modulation to a timer unit 38 designed as a high-end timer. In this example embodiment, a runtime is determined by a design and thus a complexity of the valve to be acted upon; requirements are accordingly scalable. In the event that the valve is acted upon by valve output stage 32, a high performance and thus capacity is provided. A functionality for synchronizing the valve may also be implemented by software. In this system 34, a high flexibility is provided in the low-end and in the high-end range. A number of the second connections to timer unit 38 is smaller than in system 26 presented in FIG. 3.

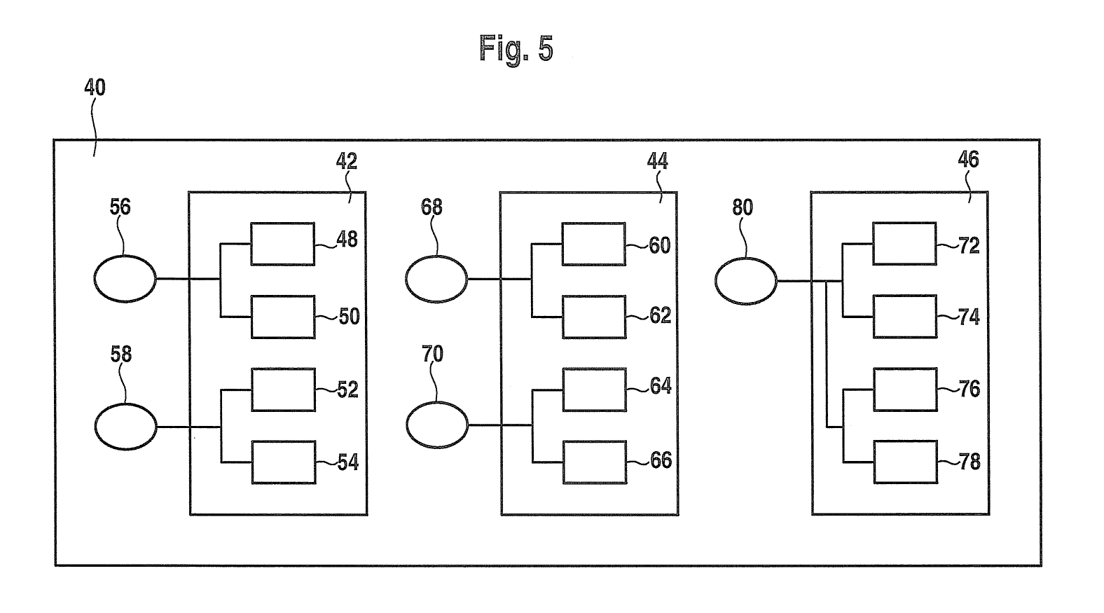

The example embodiment of a system 40 shown in FIG. 5 has an example embodiment of a first valve output stage 42, a second valve output stage 44, and a third valve output stage 46, respectively. In this context, first valve output stage 42 has a “valve output stage no. 1” 48, a “valve output stage no. 2” 50, a “valve output stage no. 3” 52, and a valve output stage no. 4” 54. “Valve output stage no. 1” 48 and “valve output stage no. 2” 50 are connected via an X-oriented high-end timer 56. “Valve output stage no. 3” 52 and “valve output stage no. 4” 54 are connected to a Y-oriented high-end timer 58. Second valve output stage 44 has a “valve output stage no. 5” 60, a “valve output stage no. 6” 62, a “valve output stage no. 7” 64, and a valve output stage no. 8” 66. In this example embodiment, it is provided that “valve output stage no. 5” 60 and “valve output stage no. 6” 62 are connected to an X-oriented high-end timer 68. “Valve output stage no. 7” 64 and “valve output stage no. 8” 66 are connected to a Y-oriented high-end timer 70. Third valve output stage 46 has a “valve output stage no. 9” 72, a “valve output stage no. 10” 74, a “valve output stage no. 11” 76, and a valve output stage no. 12” 78, that are all connected to an X-oriented high-end timer 80.

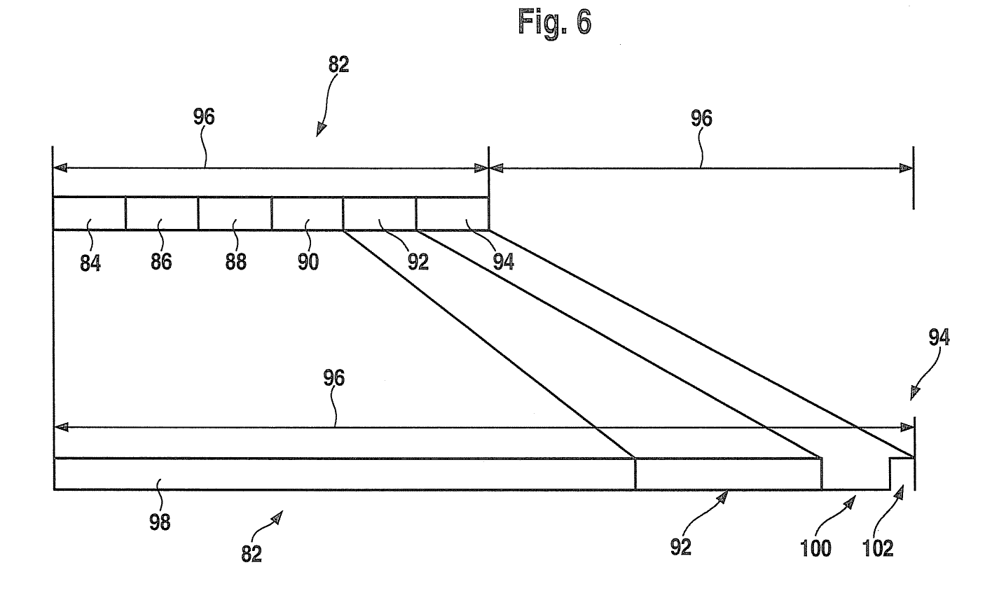

FIG. 6 shows in a schematic representation in different resolutions an example embodiment of a serial protocol 82. In this context, protocol 82 is scaled down in an upper region of FIG. 6 and shown in more detail and thus enlarged in a lower region of FIG. 6.

For this protocol 82, in the upper region a first data block 84 for a “first valve control value,” a second data block 86 for a “second valve control value,” a third data block 28 for a “third valve control value,” a fourth data block 90 for a “fourth valve control value,” a first synchronization block 92, which in this instance is also provided for auxiliary information “aux,” and a second synchronization block 94 are shown. A cycle 96 of this protocol 82 has a length of 250 μS.

When protocol 82 is used to handle data, it being provided that a plurality of data is sent from a transmitter to a receiver simultaneously using a serial data flow on one line, this data flow is transmitted using serial protocol 82 that includes data blocks 84, 86, 88, 90 and synchronization blocks 92, 94.

In the lower region of FIG. 6, in the enlarged illustration of protocol 82, a combination 98 of the first four data blocks 84, 86, 88, 90 for the four valve control values is depicted. This combination 98 is provided for two channels, in this context a cycle has a length of 4 μS for each bit. In this example embodiment, the additional data bits from first synchronization block 92 are used for different data. A stop bit 100 and a start bit 102 of second synchronization block 94 are additionally shown in the enlarged illustration of data flow 82 in the lower region of FIG. 6.

1-12. (canceled)

13. A method, comprising:
transmitting a serial data flow, with which a plurality of data is transmitted simultaneously per line, using a serial protocol that is formed from data blocks and synchronization blocks;
wherein in one cycle of the protocol, data blocks, a resynchronization block, a data block having auxiliary information, and a master synchronization block are provided.

14. The method according to claim 13, wherein the data blocks are used to control two valves having a frequency and period duration, respectively, and the auxiliary information is used to turn on and off the valves.

15. The method according to claim 13, wherein each data block is shorter than a low phase of the master-synchronization block.

16. The method according to claim 13, wherein the resynchronization block is shorter than a low phase of the master synchronization block.

17. The method according to claim 13, wherein the protocol is generated by a timer unit.

18. The method according to claim 13, wherein a receiver is controlled by a transmitter using the serial protocol.

19. The method according to claim 12, wherein the data are transmitted between a transmitter and a receiver taking into account a synchrony.

20. The method according to claim 13, wherein a receiver is newly synchronized after one cycle.

21. A system, comprising:
a device adapted to transmit a serial data flow, with which a plurality of data is transmitted simultaneously per line, using a serial protocol that is formed from data blocks and synchronization blocks;
wherein in one cycle of the protocol, data blocks, a resynchronization block, a data block having auxiliary information, and a master synchronization block are provided.
